(19) United States
(12) Patent Application Publication
(10) Pub. No.: US 2005/0034081 A1
(43) Pub. Date: Feb. 10, 2005

(54) Electronic equipment

(76) Inventors: Tamotsu Yamamoto, Ashiya-shi (JP); Keiji Kaizaki, San Diego, CA (US); Tsuyoshi Yoshiyama, Osaka-shi (JP); Nobuko Naito, Amagasaki-shi (JP)

Correspondence Address: RATNERPRESTIA, P O BOX 980, VALLEY FORGE, PA, 19482-0980, US

(21) Appl. No.: 10/891,864

(22) Filed: Jul. 15, 2004

(30) Foreign Application Priority Data
Jul. 16, 2003 (JP) 2003-275148

(51) Int. Cl. G09G 5/00; G09G 5/08

(52) U.S. Cl. 715/810; 345/167; 715/828; 715/841; 715/842; 715/843; 715/835; 715/837; 715/836; 715/840; 715/846; 715/851; 715/854; 715/855

(57) ABSTRACT

Electronic equipment includes display having menu windows, and a trackball device as an input operation unit. On a menu window, icons are arranged in a circle, and at the center of the circle, a center icon is located. In input operation, the user manipulates the exposed portion of a ball of a trackball device. Circumferential rotation of the ball on a rotation axis (where, the rotation axis is the line connecting the rotation center of ball and the top point of the exposed portion of ball) enables the cursor to go around icons, and the user can select a desired icon among the icons. On the other hand, the user can move the cursor from any one of the icons to the center icon through radial rotation of the ball in a direction tangential to the rotation axis.

### TECHNICAL FIELD

The present invention relates to electronic equipment that enables a user to perform selection, through an input operation unit, from icons representing various functions shown on the display unit.

### BACKGROUND ART

The ever-increasing level of reduction in size and weight of electronic equipment has encouraged the widespread use of mobile electronic devices.

When using such a mobile device, in most cases, the user selects a desired function, through input operations, from the icons shown on the display.

Here will be described the structure and operation of a conventional mobile electronic equipment disclosed in Japanese Patent Non-Examined Publication No. 2002-351598, with reference to accompanying drawings.

FIGS.7A, 8A, and 9A show the structure of conventional mobile electronic device, and FIGS. 7B, 8B and 9B show display examples on the screen.

The conventional device, as shown in FIG. 7A, has main unit 1 generally shaped into a rectangular parallelepiped. Display 2 is disposed in the upper section on the front side of main unit 1. Main unit 1 contains cross keys 5 involving confirmation key 4 and Cursor keys 5A-D in the lower section. Cursor keys 5A-D have four keys—up arrow key 5A, down arrow key 5B, left arrow key 5C, and right arrow key 5D—disposed in the diamond arrangement around confirmation key 4 as center.

In a section lower than cross keys 5, a numeric keypad (not shown nor described in the explanation) is disposed.

When the user presses any one of cross keys 5 including confirmation key 4, the switch (not shown) corresponding to the key pressed turns ON.

In addition, main unit 1 may contain a camera (not shown) on the backside.

Through operations via the components above, a signal is inputted into controller 10 of main unit 1. In response to the signal input, controller 10 controls the operation, for example, changes a screen on display 2.

Now will be described input operations and changes in display according to the input operations.

When main unit 1 is turned ON, display 2 shows the main menu having icons 11 arranged, for example, in two in-line rows, as shown in FIG. 7B. In the main menu, cursor 12 highlights one of icons 11. Throughout the drawings showing the screen, diagonally shaded areas show the position cursor 12 stays.

To select a desired function from main menu of FIG. 7B, the user operates cursor keys 5A through 5D so as to move cursor 12 in an intended direction. The pressing operation produces a switch signal corresponding to the key pressed and the signal is transmitted to controller 10. According to the signal, controller 10 moves cursor 12 to the next icon in a “step-by-step”manner.

The user operates cursor keys 5A-D until cursor 12 reaches the desired icon, and then presses confirmation key 4 shown in FIG. 7A.

The selecting operation will be given in the description below, taking the case in which the user selects the “Camera” function out of icons 11 shown in the main menu.

Through the key operation described above, the user moves cursor 12 onto “Camera” icon and presses confirmation key 4. Receiving a switch signal produced by the key operation, controller 10 controls display 2 to change the main menu to the submenu of “Camera” function as shown in FIG. 8B.

The “Camera” submenu shows nine job-options of “Camera” (as icons 11 on the submenu) in 9 rows in the screen. Icon 11A at the lowest represents “return-to- main menu” function.

Like in the main menu, cursor 12 appears in the “Camera” submenu and highlights a job option. Pressing up arrow key 5A or down arrow key 5B outputs a switch signal corresponding to the key pressed. According to the signal, controller 10 moves cursor 12 upward or downward.

As is the case in the main menu, cursor 12 moves across the icons with “step-by-step” movement—each time up arrow key 5A is pressed, cursor 12 moves one-step up from the current position; on the other hand, each time down arrow key 5B is pressed, cursor 12 moves one-step down from the current position.

To select the “Image” function of icons 11, as shown in FIG. 8B, the user positions cursor 12 onto the “8. Image” option by using key 5A or key 5B, and presses confirmation key 4.

FIG. 8A shows confirmation key 4 (indicated by diagonal lines) to be pressed.

In response to the signal generated by the push of confirmation key 4, controller 10 captures image via the camera (not shown) and shows, as shown in FIG. 9B, the image and pointer 13 on display 2. At the same time, display 2 shows icon 11B, which enables the user to go back to the “Camera”submenu, in a lower position in the screen.

FIG. 9B schematically shows the image on the screen. When going back to the “Camera” submenu after confirming the image on the screen, the user operates cursor keys 5A through 5D according to the position of pointer 13. In the state shown in FIG. 9B, for example, the user positions pointer 13 onto icon 11B by pressing down arrow key 5B, and then presses confirmation key 4. Through the operation, the screen goes back to the “Camera” submenu shown in FIG. 8B.

However, the conventional electronic device is so designed that the menus contain icons 11 in a “stacked” or grid-like arrangement. Therefore, in particular, to move cursor 12 from the top-left icon “Microphone” to the bottom-right icon “Accessories” in the grid arrangement like FIG. 7B, or to step cursor 12 up from the top icon “1.REC” to the bottom icon “9.Menu” in the stacked arrangement like FIG. 8B, the user has to push cross keys 5 several times for the selection.

Besides, as is the case of the menu arranged in line shown in FIG. 8B, icon 11A as a bridge between menus is often located at the bottom. There has been increasing the demand for quickly changing menus by simple key operations.

### SUMMARY OF THE INVENTION

An electronic device contains a) display for displaying icons, each of which represents a preset function, and a cursor showing the current position; b) an input operation unit enabling operations with circumferential and radial movement; c) a controller for controlling the display and the input operation unit. The display provides layers of menus. On a menu located on at least one layer, the display unit shows icons circularly arranged, with an icon the center. With the structure above, the input operation unit accepts a circumferential operation and produces a signal corresponding to the operation. According to the signal, the controller moves the cursor along the circularly arranged icons. On the other hand, when receiving a signal corresponding to a radial operation from the input operation unit, the controller moves the cursor from the periphery to the center icon. That is, moving from the peripheral icons to the central icon, or vice versa, can be done by a single radial operation. For ease of use, a more frequently used function should preferably be allocated to the central icon.

### BRIEF DESCRIPTION OF THE DRAWINGS

FIG. 1 is a perspective view of mobile electronic equipment of an exemplary embodiment of the present invention.

FIG. 2 is a perspective view of a push switch-equipped trackball device, which is mounted as an input operation unit onto the mobile electronic equipment.

FIG. 3A shows an operation of the input operation unit of the equipment of the present invention, and FIG. 3B shows a display on a display unit corresponding to the operation in FIG. 3A.

FIG. 4A shows another operation of the input operation unit, and FIG. 4B shows a display on the display unit corresponding to the operation in FIG. 4A.

FIG. 5A shows still another operation of the input operation unit, and FIG. 5B shows a display on the display unit corresponding to the operation in FIG. 5A.

FIG. 6A shows one operation of the input operation unit, and FIG. 6B shows a display on the display unit corresponding to the operation in FIG. 6A.

FIG. 7A shows an operation of an input operation unit using conventional mobile electronic equipment, and FIG. 7B shows a display on a display unit corresponding to the operation in FIG. 7A.

FIG. 8A shows another operation of the input operation unit of the conventional equipment, and FIG. 8B shows a display on the display unit corresponding to the operation in FIG. 8A.

FIG. 9A shows still another operation of the input operation unit using conventional equipment, and FIG. 9B shows a display on the display unit corresponding to the operation in FIG. 9A.

### DESCRIPTION OF THE INVENTION

The electronic equipment of the present invention contains i) a display unit showing menus having icons in an annular or circular arrangement with an icon as a center, and ii) an input operation unit enabling continuous operations with circular movement along the annularly arranged icons. The structure allows the user to quickly move the cursor onto a desired icon with a smooth circular movement, eliminating the frequent use of the individually disposed cursor movement keys.

Furthermore, by virtue of the circular arrangement of icons, the cursor can bypass other icons and move directly to the central icon. Therefore, for an efficient operation, an icon with high frequent use or importance, such as a menu-layer changing icon, should preferably be the central icon.

According to another aspect of the electronic equipment of the present invention, a window-changing function (e.g. returning to a previous window) is set to the central icon. Since the central icon is evenly spaced from the surrounding icons, the user can go between the main menu and a sub menu with easy and quick operation.

According to still another aspect, the electronic equipment contains a trackball device as the input operation unit. The trackball device is so designed that an exposed upper portion of the trackball can be rotated on the central axis including the center of gravity of the ball. The user can move the cursor on the circle of icons with continuous circular movement of the trackball. An intuitive similarity between the circularly arranged icons and the rolling operation of the trackball allows the user to select an intended icon with ease.

According to yet another aspect of the electronic equipment, the trackball device contains a guide ring around the exposed upper portion of the ball. The guide ring is an annular step which guides the user's finger in the trackball operations. The user can manipulate the upper portion of the ball, by sliding a finger along the guide ring, creating a stable and smooth rotation.

The electronic equipment of the present invention has a push switch. When the ball of the trackball device presses the push switch, the switch outputs signals to the connected controller. Receiving the signal, the controller selects the icon indicated by the cursor and calls the function allocated to the icon. Thus, the switch-equipped trackball can perform both the selection and confirmation, providing users with simple and quick operations.

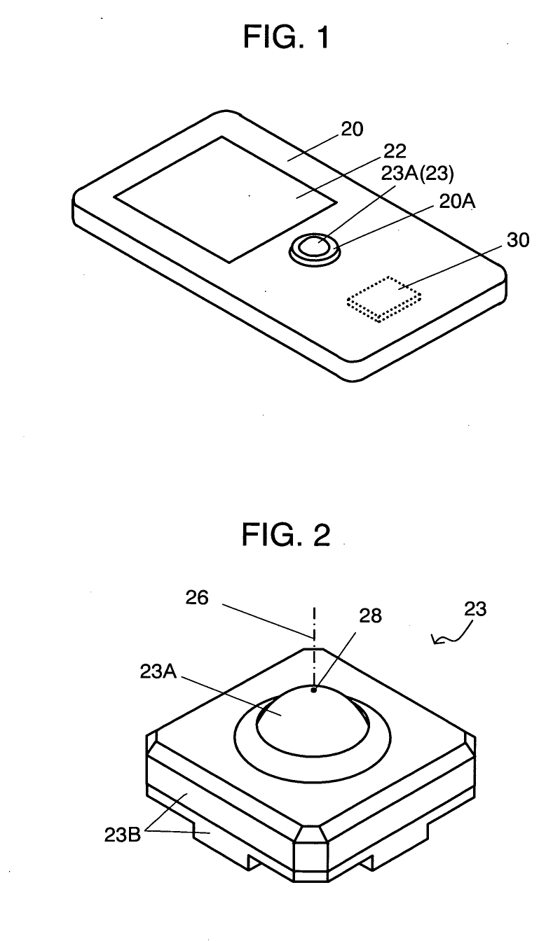

An exemplary embodiment of the present invention is described hereinafter with reference to the accompanying drawings, FIG. 1 through FIG. 6. The explanation overlapping with that in the section of Background of Art will be omitted in the description below.

### Exemplary Embodiment

The electronic equipment of the embodiment will be described below in the case that the equipment is employed for a mobile device.

FIG. 1 is a perspective view of mobile electronic equipment of the embodiment. FIG. 2 is a perspective view of a push switch-equipped trackball device, which is mounted as an input operation unit onto the mobile electronic equipment.

As shown in FIG. 1, main body 20 of the mobile electronic equipment is generally shaped into a rectangular parallelepiped. In the upper front of main body 20, display unit 22, such as liquid crystal display (LCD) or EL display, is disposed. Push switch-equipped trackball device 23, which is an input operation unit of the electronic equipment, is located under display unit 22.

Trackball device 23 is formed of i) ball 23A mounted on the device with an upper portion exposed outside from main body 20, and ii) a detector (not shown) for detecting the direction and degree of the rotation of ball 23A. Pressing down ball 23A enables the push switch (not shown), which is disposed in the direction of pressing ball 23A in case 23B, to change its state. Controller 30 in main body 20 controls display unit 22 and trackball device 23. In addition, main body 20 accommodates circuitry therein, such as a memory circuit, a power supply circuit, and driving circuit for display unit 22. In a lower section than trackball device 23 on the front face of main body 20, numeric keypad (not shown nor described in the embodiment) is disposed. Like in the conventional structure, a camera (not shown) is mounted on the rear side of main body 20. The circuitry and the camera are controlled by controller 30.

For detecting the rotation of ball 23A, other than the structure introduced in the embodiment, the detecting means may be formed of a combination of a switch and an encoder, or it may be a magnetic detecting component. Accordingly, the detector and the push switch are not limited to those accommodated in case 23B as illustrated in the exemplary embodiment.

Such structured mobile electronic equipment of the present invention enables the user to select a desired icon with simple operations by virtue of the improved arrangement of icons on display 22 and easy operations having an intuitive similarity to the arrangement. Controller 30 of the equipment controls display 22 so as to display layers of menus. As an example of the multi-layer menu, display windows of the main menu and a submenu will be described below. Display 22 may show several submenus, not limited to the one described below. In addition, while these menu windows are designated for convenience as the “main menu” and the “submenu” in the exemplary embodiment, these windows may have other designations as well.

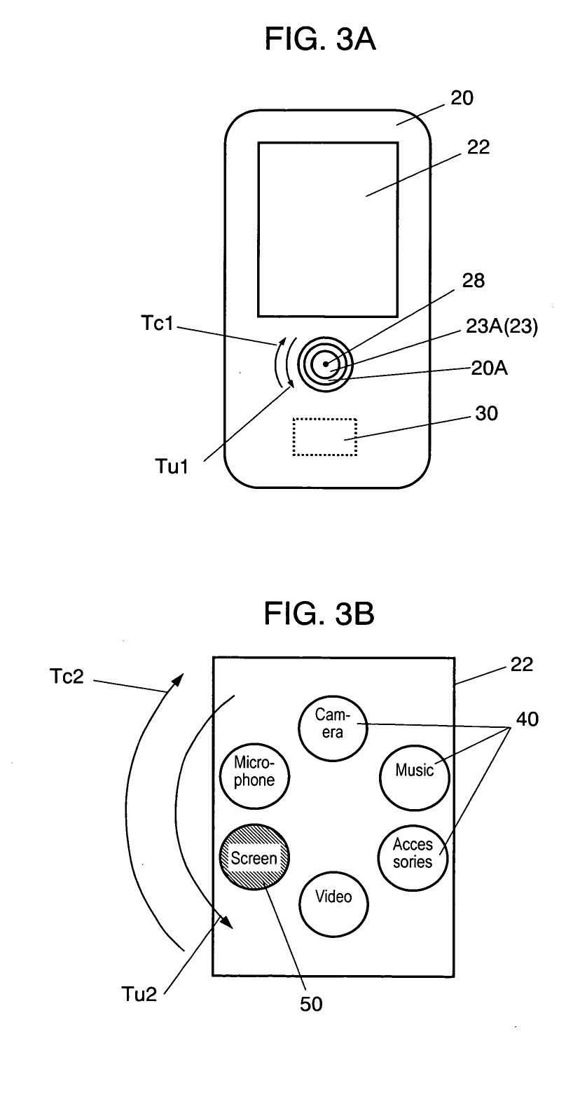

Detailed descriptions of operations on the menus are set forth below with reference to the drawings. FIGS. 3A, 4A, 5A and 6A show operation states of the mobile electronic equipment in accordance with an exemplary embodiment of the present invention; and FIGS. 3B, 4B, 5B and 6B show displays that follow, respectively.

First, operations on the main menu will be described.

When main body 20 (FIG. 3A) is turned ON, the main menu appears on display 22. The main menu of FIG. 3B shows icons in a circle—six icons 40 are located on the vertices of a regular hexagon on display 22.

Each of icons 40 in a circle is represented by the function allocated thereto, for example, “Camera”, “Music”. When the user selects one of them, display 22 changes the main menu into the submenu linked to the icon selected.

The main menu also shows cursor 50, which highlights one of icons 40.

FIG. 3A schematically shows operations of trackball device 23, while in the schematic view of FIG. 3B, cursor 50 is currently positioned at the icon indicated by diagonal lines, i.e., the “Screen” icon.

The user rotates the exposed upper portion of ball 23A in the circumferential direction indicated by the arrows in FIG. 3A, so that ball 23A rotates on rotation axis 26 including the center of the rotation and top 28 of the exposed upper portion. That is, rotation axis 26 passes through the center of gravity of ball 23A. Rotation axis 26 is indicated by dash-dot lines in FIG. 2, and top 28 is indicated by a black dot in FIG. 2 and FIG. 3A.

When rotated on rotation axis 26, ball 23A circumferentially rotates by an angle, and a signal corresponding to the rotation angle is fed into controller 30. According to the direction and angle of the rotation, controller 30 continuously moves cursor 50 along the circle of icons 40.

For example, when the user rotates ball 23A in the direction indicated by arrow Tc1 of FIG. 3A (i.e., in a clockwise direction), cursor 50 also travels clockwise, as is shown by arrow Tc2 of FIG. 3B, from “Screen” through “Microphone”, “Camera”, “Music”, and so on. On the other hand, when ball 23A is rotated counterclockwise, i.e., in the direction indicated by arrow Tu1, cursor 50 goes around counterclockwise as is indicated by arrow Tu2.

The aforementioned circumferential rotation of the trackball differs from the typical rotation of the trackball in which the ball is rotated in any given direction with respect to the center of gravity of the ball. To provide a smooth and steady rotation in the circumferential direction, trackball device 23 contains guide ring 20A around the exposed portion. Guide ring 20A is disposed on trackball device 23 so as to rise with a height from the upper surface of main body 20, and so as to surround with a width the exposed portion of ball 23A.

In the rotating operation, the user touches ball 23A with a thumb or a finger and rotates the ball along guide ring 20A. Guide ring 20A enables ball 23A to stably rotate on a level surface, eliminating unintended movement of the thumb or finger. In this way, the user performs the rotating operation on aforementioned rotation axis 26 in a stable manner, accordingly, cursor 50 is continuously moved along the circle of icons.

As described above, cursor 50 moves in a direction the same as that of ball 23A. The intuitional match between the movement of the cursor and the ball allows the user to easily select a desired icon among icons 40.

For example, to select the “Camera” icon, the user positions cursor 50 on the “Camera” icon by circumferentially rotating ball 23A, and then pushes the top of ball 23A. The pushing activates a switch (not shown) to produce a switch signal for selecting the “Camera” icon. Receiving the signal, controller 30 calls a submenu of the “Camera” function on display 22.

Now will be described operations on the submenus.

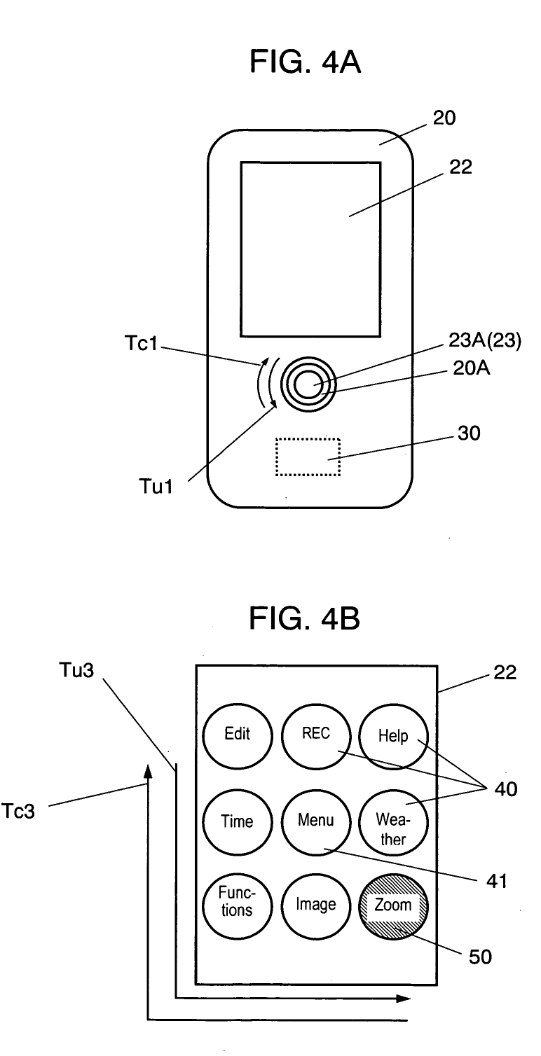

FIG. 4B shows layout of, for example, the “Camera” submenu. In display 22 of FIG. 4B, icons 40 formed of nine icons are located in a 3×3 arrangement. In the submenu, the “Camera”-related functions are allocated to the outer eight icons. The submenu has the layout similar to that of the main menu shown in FIG. 3B, where center icon (first icon) 41 is situated at the center of eight icons 40. In other words, center icon 41, in which the function of return-to-main menu is defined, is adjacent to all of eight icons 41. Display 22 also shows cursor 50, which highlights a currently selected icon of icons 40, on the submenu.

With the operation similar to that carried out on the main menu, the user selects a desired icon among eight icons 40 in the perimeter. That is, the user rotates the exposed upper portion of ball 23A clockwise (in the direction indicated by arrow Tc1 in FIG. 4A) or counterclockwise (Tu1). In the rotation, as described above, ball 23A rotates on rotation axis 26 including the center of the rotation and top 28 of the exposed upper portion.

According to the direction and angle of the rotation, controller 30 continuously moves cursor 50 along the circle of icons 40 in the direction indicated by arrow Tc3 (i.e., clockwise) or Tu3 (counterclockwise) of FIG. 4B. Now suppose that cursor 50 highlights the “Zoom” icon. When the user rotates ball 23A in the direction indicated by arrow Tc1 of FIG. 4A (i.e., in a clockwise direction), cursor 50 also travels clockwise, as is shown by arrow Tc3 of FIG. 4B, from “Zoom”, “Image”, “Functions”, “Time”, and so on.

The user controls the rotation speed and positions cursor 50 onto an intended icon 40, and then presses the top of ball 23A. In response to the switch signal, controller 30 requests display 22 to change the window linked with the icon selected, or performs the function allocated in the icon.

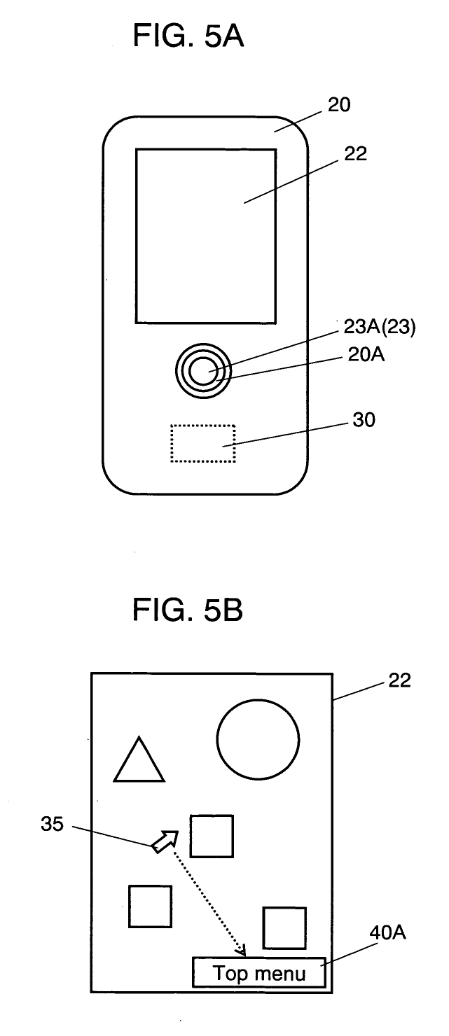

For example, when the user positions cursor 50 onto the “Image” icon and pushes ball 23A, controller 30 captures an image from the camera (not shown) and, as shown in FIG. 5B, shows the image and pointer 35 on display 22. In-detail description on the display shown in FIG. 5B will be omitted because of the similarity to conventional ones.

In FIG. 5B, icon 40A bearing “Top Menu”, which enables the user to go back the “Camera” submenu, appears at the bottom of display 22. Controller 30 controls pointer 35 for moving and selecting operations so as to follow the signal from trackball device 23.

The user can quickly move pointer 35 with ease, since ball 23A of trackball device 23 can be rotated in all directions.

To change the display shown in FIG. 5 back to the “Camera” submenu, the user rotates ball 23A (FIG. 5A) and positions pointer 35 onto icon 40A and then pushes ball 23A. The depression activates the switch (not shown) to produce a signal. Receiving the signal, controller 30 changes from the image display captured by the camera to the “Camera” submenu shown in FIG. 4B.

In the “Camera” submenu shown in FIG. 4B, center icon 41 has the “return-to-main menu” function. The arrangement of icons allows the user to go back to the main menu with quick operation.

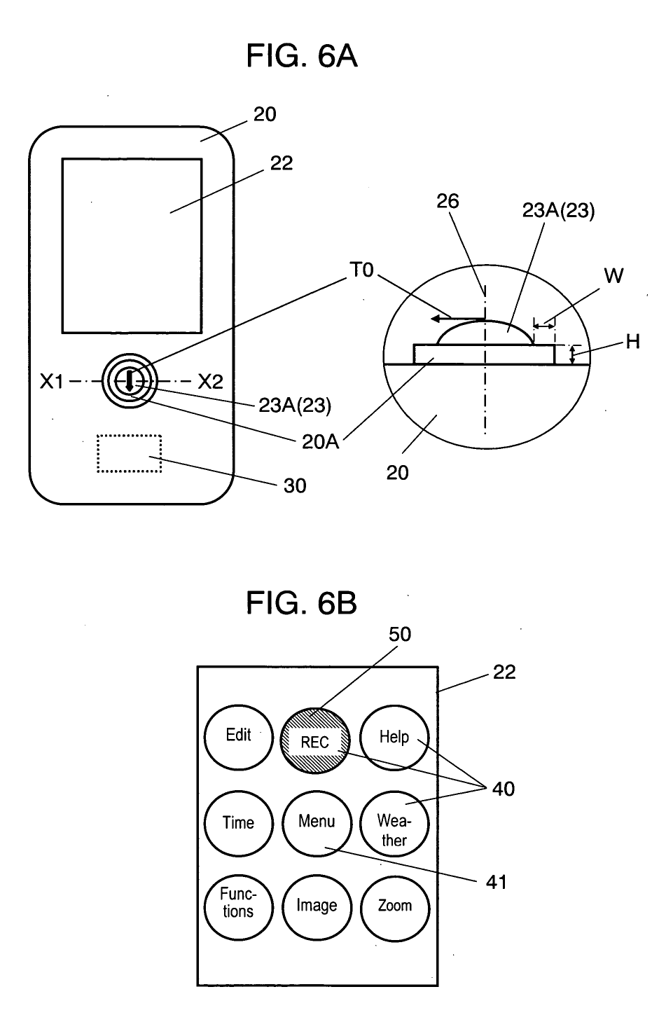

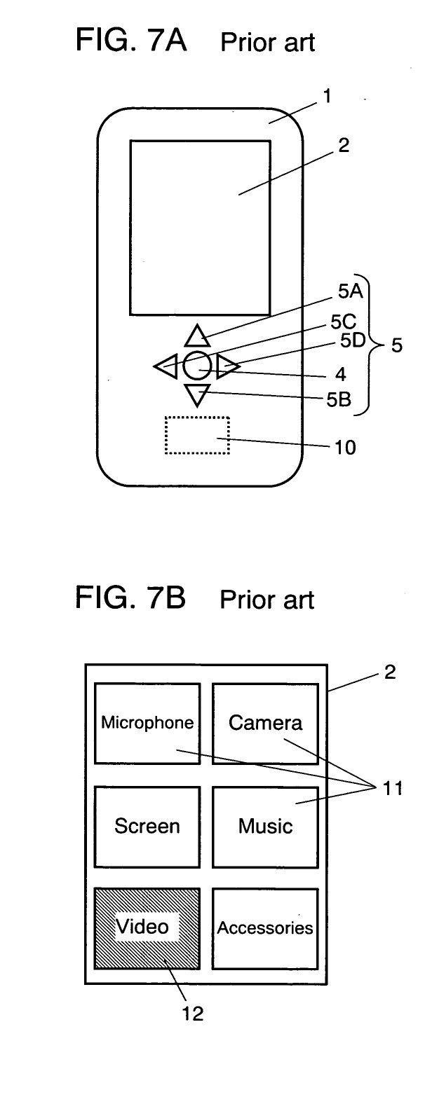

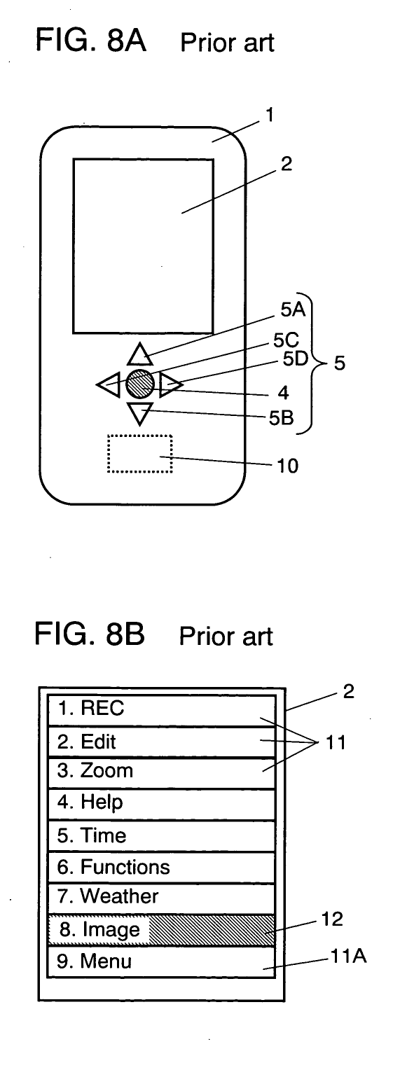

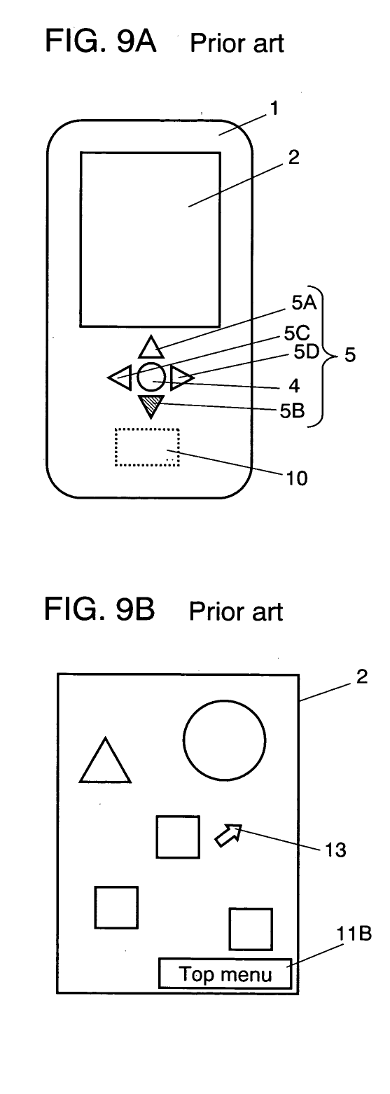

Now will be described operations on the submenus with reference to FIG. 6. The description is given hereinafter, taking the case in which the user moves cursor 50 from one of eight peripheral icons 40 to center icon 41. To position cursor 50 to center icon 41, the user rotates ball 23A of trackball device 23 toward the direction of center icon 41. In the operation, with the application of force T0, the top of the exposed portion of ball 23A is moved tangentially with respect to the line connecting the rotation center of ball 23A and the top point of the exposed portion of the ball. As a result, ball 23A radially rotates. According to the signal corresponding to the degree of rotation, controller 30 moves cursor 50 onto center icon 41.

FIG. 6B shows the cursor 50 highlighting the “REC” icon. When the top of ball 23A is operated, as shown in FIG. 6A, in the direction indicated by arrow T0 (i.e., in a radial direction) by the user's finger, ball 23A rotates in the direction indicated by arrow T0. In this way, the user positions cursor 50 onto central “Menu” icon 41 from “REC” icon 40. The view illustrated in the circle in FIG. 6A schematically shows the essential part, taken along the line X1-X2, of trackball device 23. Here will be given description on the radial operation onto ball 23A, referring to the sectional view. Operating ball 23A in a radial direction means that ball 23A rotates, on a plane having rotation axis 26, in the direction indicated by arrow T0 at right angles to rotation axis 26. Guide ring 20A has a height H from the upper surface of main body 20 and a width W around the exposed portion of ball 23A. Here, the height H is not required to be equivalent along the width direction, and the width W are not required to be equivalent around the ball.

The radial operation on ball 23A above enables cursor 50 to bring back to center icon 41 from any other icon, as well as from the “REC” icon.

As described above, central icon 41 is adjacent to surrounding eight icons 40. With ball 23A rotatable freely in all directions, the user can position cursor 50 quickly and directly from each icon 40.

Following the operation above, the user pushes down ball 23A, with cursor 50 positioned on central icon 41. The pressing-down operation actuates a switch disposed in the depressing direction of ball 23A to output a signal. Receiving the signal, controller 30 changes the current display on display 22 back to the main menu shown in FIG. 3B.

Push switch-equipped trackball device 23 thus allows the user to easily perform a series of operation: from selection to confirmation of icons.

In addition, each menu shows icons 40 in a circle. Here, the circle means an arrangement that icons 40 encircle central icon 41. By virtue of the arrangement, the user can quickly position cursor 50 onto an intended icon in the circle by rotating the exposed position of ball 23A in a circumferential direction. As a result, the user can continuously move cursor 50 along the circle of icon 40. Compared to the conventional structure-in which the four cursor keys have to be used repeatedly to reach the destination, the circular icon-arrangement provides the user with efficient operations.

Furthermore, in the center of the circle of icons 40, icon 41 having a frequently used function, such as “return-to-menu”, is located. Therefore, cursor 50 can be moved straight back to center icon 41 from any icon of peripheral icons 40. Such an efficient arrangement provides the user with user-friendly operation, for example, a quick screen change.

Besides, cursor 50 takes a short route in moving between peripheral icons 40 and center icon 41 because of their proximity.

When the user reselects an icon in peripheral icons 40 after positioning cursor 50 onto center icon 41, the user operates ball 23A with radially outward rotation, from icon 41 directly to a desired icon in the circle.

According to the mobile electronic equipment of the exemplary embodiment of the present invention, the user can select a desired icon, in a quick and simple manner, among icons 40 and 41 by operating trackball device 23 in a circumferential or radial direction.

Although trackball device 23 is preferable for an input operation unit because of its small footprint and ease of use, there may be other options, as long as the device can be operated in a circumferential or radial direction with intuitive similarity between the moving direction of the device and the cursor move. For example, a flat touch panel or a joystick may be an alternative.

Although the screen-changing function is set to center icon 41 in the description of the exemplary embodiment, it is not limited thereto.

The structure for menu selection of the present invention is particularly effective in making the best possible use of the available display and input operation unit, such as mobile electronic equipment. Such a user-friendly structure—enabling the quick selection with the circumferential or radial operation from the circular arrangement of icons—is not only for mobile devices, but also widely adaptable for other electronic devices.

The electronic equipment of the present invention contains i) a display having a menu on which a center icon is encircled by a plurality of icons, and ii) an input operation unit enabling circumferential and radial operations, thereby allowing the user to select icons with ease. The structure above can be widely used for devices employing the “selecting-icon-from-menu” style; particularly effective in mobile electronic equipment, where ease-of-use features are demanded in a minimized space.

1. Electronic equipment comprising:
a display for displaying a plurality of icons and a cursor for designating the icons;
an input operation unit for performing data selection from the display; and
a controller for controlling the display in response to signaling from the input operation unit,
wherein the controller requests the display to show multi-layer menus; a menu on at least one level of the multi-layer menus has a layout in which a first icon of the icons is encircled by others of the icons and each of the icons has different functions;
the input operation unit indicates circumferential and radial motion,
the cursor travels between the others of the icons in response to the circumferential motion; and
the cursor travels between the first icon and any others of the icons in response to the radial motion.

2. The electronic equipment of claim 1, wherein the first icon has a screen-changing function, and when the first icon is selected by the input operation unit, the controller controls the display to change a current display into a menu on a different level.

3. The electronic equipment of claim 1, wherein the others of the icons are arranged in a circle.

4. The electronic equipment of claim 1, wherein the input operation unit is a trackball device,
the controller enables the cursor to go around the circle of the others of the icons in response to the circumferential motion of the ball on a rotation axis including a center of gravity of the ball, and
the controller enables the cursor to move between the first icon and the others of the icons in response to the radial motion of the ball in the direction of the rotation axis of the ball.

5. The electronic equipment of claim 4 further comprising a guide ring disposed around the ball.

6. The electronic equipment of claim 5, wherein the guide ring guides a user's finger in the circumferential motion of the ball.

7. The electronic equipment of claim 4, wherein the controller controls positioning the cursor on the circle of the others of the icons according to a direction and an angle of the ball's rotation on the rotation axis.

8. The electronic equipment of claim 4 further comprising a push switch which outputs a signal when the ball is pressed, wherein the controller determines one of the icons selected by the cursor or carries out a function assigned to the selected one of the icons, according to the signal.

9. The electronic equipment of claim 4 further comprising a push switch in a direction of depressing the ball,
wherein the ball is held so as to move along the rotation axis, and
the controller carries out a function assigned to any one of the icons when the switch is turned on with the cursor positioned on said any one of the icons.
